(19) United States
(12) Patent Application Publication
(10) Pub. No.: US 2010/0018837 A1
(43) Pub. Date: Jan. 28, 2010

(54) Flat bottom silo for storing and conveying light and empty containers in bulk

(76) Inventor: Daniel Angel Perez, St Martin (AR)

Correspondence Address: JACKSON WALKER, L.L.P., 112 E. PECAN, SUITE 2400, SAN ANTONIO, TX, 78205, US

(21) Appl. No.: 12/460,465

(22) Filed: Jul. 20, 2009

(30) Foreign Application Priority Data
Jul. 22, 2008 (AR) 2008 0103167

(51) Int. Cl. B65G 37/00

(52) U.S. Cl. 198/347.1

(57) ABSTRACT

Flat bottom silo for storing and conveying light and empty containers in bulk, wherein the silo defines a transient storage housing having an upper loading mouth and a lower unloading bottom communicated with at least one engine powered conveying belt. Into said transient storage housing there are ordered groups of provisory elongated baffle plates, distributed as per horizontal rows provided at different heights, for avoiding the formation of excessive accumulation columns of containers; wherein said unloading bottom embraces a surface equivalent to the lower quadrangular base of the housing, in correspondence with which the engine powered belts are provided, extending as per a horizontal plane, to assist in exiting the containers being unloaded.

### BACKGROUND OF THE INVENTION

The instant invention relates to a flat bottom silo for storing and conveying light and empty containers in bulk, such as light containers resulting from blow molding and which are stored temporarily, in line with further labeling and filling steps.

The silo of the invention proposes a novel constructive solution, as a result of which, factors producing scratches, bruises and deformations in empty containers being transiently stored and conveyed to unloading for the further steps are highly reduced.

More particularly, the instant invention refers to a transient storage silo, of the type comprising a container housing with an upper loading mouth and a bottom including a lower unloading region communicated with at least one engine powered conveying belt, from which containers are moved to other means conveying them to the filling and labeling machines, as the case may be.

To avoid damage on the containers, the inner part of said transient storage housing is divided into overlapped minor housings, in order to form large spaces wherein several overlapped mixed containers may result in said damages and deformation, especially when they are displaced downwards due to gravity. In other cases, the target is to avoid formation of very high columns of stacked accumulated containers. In both cases, flat baffle plates are transiently included inside said housings, which are distributed according to the strength and dimensions of the containers in order to avoid the formation of excessively high accumulation columns, generating the mentioned inconveniences. Particularly, the flat bottom silo of the invention has a special shape and distribution of said planar baffle plates distributed inside the transient storage housing, from which it is possible to determine, in a very efficient way, a controlled height for accumulated containers, easily adjustable as a function of their physical. features, in turn affording a very wide discharge completely eliminating the possibility of undue throttles.

The invention relates to a new combination of means for obtaining a better result, being unforeseeable and surprising also for those skilled in the art. Consequently, the constructive and functional apart from being novel, the constructive and functional design shows inventive activity thus complying with the requirements of the Law to be considered a patent of invention.

### PRIOR ART

In most of facilities manufacturing this kind of plastic light containers, the blow molding step is not carried out in line with further steps of filling and labeling, since different operations are involved.

Therefore, this kind of silo is needed for storing and conveying containers, employed between said blowing step and filling or labeling step, acting as unavoidable and needed true intermediate lungs.

For example, the existence of this kind of silo is appreciated in facilities wherein several blowers are working for a single filling line.

Due to the above reasons, this type of intermediate silos are used, for example, for manufacturing plastic containers filled with edible oils, lubricant oils, shampoo, yoghurt, detergents, bleaching agents, milk, soft drinks, water, vinegar, mayonnaise, dressings, cleaning articles and any product which may be fractioned and contained into light plastic material containers.

Since silos into which containers are bulk conveyed, such that they move forwardly making frictional contact with each other, being displaced by gravity, the problem these silos have to deal with is, precisely, avoid bruising or deformation or scratching of the containers, specially in the case of clear containers.

Therefore, taking into account the mechanical strength of each container, the maximum accumulation column inside the storing housing is analyzed, such that said containers may support the different loads to which they are subjected to, without experimenting the mentioned undesirable deformations and damages.

Further, it is to be guaranteed that said maximum accumulation columns allow fluid circulation of containers, coming down in bulk by gravity, without causing undesirable jamming, which may also cause damages.

The point is attaining accumulation inside the silo, without damaging the container due to the size of the storing column formed or due to the forward movement towards the unloading region defined.

Also, it should to be taken into account that, in several cases, containers entering the silo from blowing machines are hot, this being another cause of undesirable deformation and damage. For this reason, air conditioning equipment is sometimes used for counteracting heat, thus avoiding thermal deterioration.

Conventional silos have about 5-6 meters side and six meters height, such that for containers of about 7 g weight, they have a capacity of about 500.000 units. In these cases, unloading of containers, depending on the demand of the production line, may vary from 100 to 700 containers per minute.

Present silos of this kind are those commercialized under the mark “Posimat”, different from a conventional silo since, in correspondence with their bottom, there are two articulated ramps actuated by pneumatic cylinders through which said ramps effect small movements at the silo bottom causing unloading of the containers towards a longitudinal conveying belt.

One of said ramps is associated to other pneumatic cylinders providing opening and closing of the passage to discharge.

This silo also includes at the upper portion a planar strap net distributed at different heights to avoid pressure accumulation between containers.

Further, mating with the lower portion, before said ramps, often these silos include a new planar strap mesh forming squares of 700 mm×700 mm.

Nevertheless, in spite of the presence of said strap meshes, there are several containers that cannot be stored and conveyed in these silos, mainly because the funnel formed with the articulated ramps generates jamming and friction of the containers, thus causing the mentioned undesirable bruises, deformations and flattening.

A solution was to include a larger amount of strap meshes and distributed in cascade such as to cut the column formed by container accumulation. The percentage of bruises was lower, but this seriously affected the loading capacity of the silo, since the height of container columns is much lower than that desired.

Another silo marketed under trademark “See” is cited, which comprises an upper cube and a lower truncated pyramid, the wall of which converges towards the unloading mouth wherein a flat conveying belt appears, feeding an associated elevator, located at one of its ends for removing the containers being unloaded.

The elevator has a band with plugs taking up containers from the bottom to remove them from the lower cone of the silo. It may be seen that, with determined container models, this operation also causes bruises due to the unavoidable friction produced by this loading action.

These silos may have 5-6 meters at the sides, and the outlet strap may be approximately 800 mm wide.

In order to effect the removal, said planar strap advances towards the elevator, from time to time reversing the operation for relieving pressure from the containers accumulated against the elevator.

In this case, the transient storage housing has a plurality of internal plates or panels, of about 1 m wide, which extend forming rows at different heights, and oriented at an angle of about 45°, to break the pressure of stacked and accumulated containers.

Nevertheless, these silos are not efficient for many container models and sizes, mainly because there is no effective control of the accumulation columns. Further, the distance between the last row of panels and the unloading mouth feeding the conveying belt is very large.

Further, in the lower portion of these silos a true truncated pyramid funnel is formed, causing the mentioned jamming produced by flattening and bruises of the containers.

Another known silo is that marketed under trademark “Lanfranchi”, the general shape of which is an upper cube over a truncated lower pyramid unloading on a conveying belt.

This silo includes mesh bands constituted by planar straps distributed at different heights preventing the formation of the mentioned container accumulation columns.

The disadvantages of this kind of silo are the distance between the last level of bands and the unloading mouth and the mentioned shortcoming of forming a funnel in the lower portion.

### SUMMARY OF THE INVENTION

The flat bottom silo for storing and conveying empty containers of the instant invention eliminates the frustoconical shape of the lower portion or region, such that damage risk caused by jamming near the unloading region is prevented.

In the transient storage housing, the possibility of undesirable funnels for down circulation of containers is also prevented.

The general shape of the silo of the invention is a parallelepiped structure wherein the containers entering by the upper portion, to advance downwards to the outlet, encounter special elongated baffle plates, having a particular shape and orientation, made for limiting the size of the container accumulation columns, especially those related with the height thereof.

Each baffle plate is a plated or painted steel profile, when the silo is to convey and store containers in general, or of stainless steel when intended for food product containers. These baffle plates extend from end to end between the front and rear faces of the silo, parallel to the side walls, and are distributed in rows at different height levels, at least two baffle plates per row.

Intermediate baffle plates are used, having a longitudinal central folding line to define two inclined downward planes forming an angle of about 45°, jointly with marginal planar plates, also inclined downwardly, projecting from the silo side walls.

Under the above conditions, distribution of these novel baffle plates form cross rows extending, at different heights, between the silo side walls.

The separation defined between adjacent baffle plates of the same row and between adjacent rows allows defining the capacity inside the storing housing so that containers may flow without superficial damage thereon, and limiting definitively the formation of container accumulation columns of improper dimensions.

Consequently, intermediate and marginal baffle plates having the proper size may be formed for each type or size of container, for a best utilization of the silo internal space.

A construction condition of this embodiment is that each intermediate baffle plate of a row is laterally displaced with respect to the intermediate baffle plates of adjacent rows; therefore, the accumulation columns may be controlled efficiently causing that containers flow without friction between the free zones and regions formed.

It is to be noted that the inclination of the inclined flat faces of the intermediate baffles, as well as the marginal baffle plates per se, is the minimum inclination needed for assuring an acceptable displacement of the containers towards the lower unloading region.

The silo of the invention is a flat bottom silo precisely because it is the first silo not including a funnel shape at the lower portion extending to the unloading or discharge mouth.

In fact, in this case, under the last baffle plates row, engine powered conveying belts are placed in the amount required for embracing the entire free surface determined at the lower base of the silo.

Consequently, silos using two conveying belts for receiving the load may be constructed, as well as up to four pairs of coplanar belts to cover the whole unloading face of a larger size silo.

On the basis of the above, it is clear that containers falling due to gravity over said conveying belts do not suffer any kind of throttle thus avoiding the mentioned surface deformations.

In order that the discharge or unloading be carried out without any kind of jamming or rough jumps of the containers being displaced, mating with this lower region, and inclined towards the conveyor belts, planar transversely inclined and short partitions are included, projecting from the silo side walls with a respective inclination converging towards said belts. It is also noted that over the separation space between two adjacent conveying belts, a folded sheet extends longitudinally, acting as a lower orienting and offsetting cover or mount so that the containers being unloaded be orderly distributed over the conveying belts.

Taking into account the above constructive and functional principle, the instant invention contemplates the alternative of forming silos having much lower loading capacity than conventional silos. They are mini-silos having a capacity for storing about 20,000 containers.

In fact, conventional very large silos, for storing about 500.000 units, are used for containers without labels, since friction during the containers displacement may damage the labels.

However, at present, due to operative reasons, it is necessary to use lungs for storing already labeled containers transiently.

In these cases, the usual way is to use carton boxes for holding the containers grouped per label. Then, they are moved to the production line as required, which generates cleaning problems and also surface damages on the containers.

By the use of mini-silos, the above problem will be solved definitively. To this end, groups of mini-silos aligned as per a single collecting belt are provided, wherein each silo stores groups of containers bearing the same label, such that they may be discharged orderly without the need of carton boxes.

The operator will put in use each mini-silo based on the kind of label required in each case.

Another foreseeable application is to construct truck and transport vehicle loading boxes employing the same constructive and functional principles described above. Thus, transportation of empty containers, without label, from the manufacturing plant to the filling and labeling facility is eliminated.

In fact, at present conventional trucks are used for conveying boxes containing the containers. With the alternative of the previous paragraph, containers will be contained in bulk into corresponding silo boxes, to be directly unloaded at the filling or labeling machines of the receiving facility.

From the above, the main advantages of the silo of the instant invention are evident, as compared to what is known at present in the art. The following advantages are highlighted:

The special shape of the baffles, with inclined planes distributed inside the transient storage housing, in order to obtain a controlled height of the container accumulation columns.

The condition of not generating funnels along the path for circulation of the containers, especially in correspondence with the lower unloading region.

The functional condition of attaining a fluid product removal, without throttles at the outlet portions, since the unloading mouth embraces all the surface of the silo basis.

Conveying belts covering the whole width and length of the silo unloading region, feed a respective conveyor elevator placed at an angle of 90° through which containers are removed without pressure from the column.

### Inventive Activity

No silo for conveying and storing containers of the prior art proposes, or suggest, a constructive solution such as that described above; therefore, this proposal has a clear inventive activity, apart from being novel.

### BRIEF DESCRIPTION OF THE DRAWINGS

FIG. 1 is a perspective, elevation view, showing a silo for storing and conveying containers, seen from its front face.

FIG. 2 is a perspective view, similar to that of FIG. 1, in this case seen from a point wherein the front face and a side face of the silo for storing and conveying containers meet.

FIG. 3 is a schematic cross section, in a vertical plane, showing a preferred distribution of the means ordering distribution of the containers housed in the inner transient storage housing of the silo of the invention.

FIG. 4 is a schematic view of the silo shown in FIG. 3.

In all figures, the same reference symbols correspond to the same or equivalent parts or elements constituting the exemplary embodiment of the silo of the invention.

### DETAILED DESCRIPTION OF THE PREFERRED EMBODIMENT

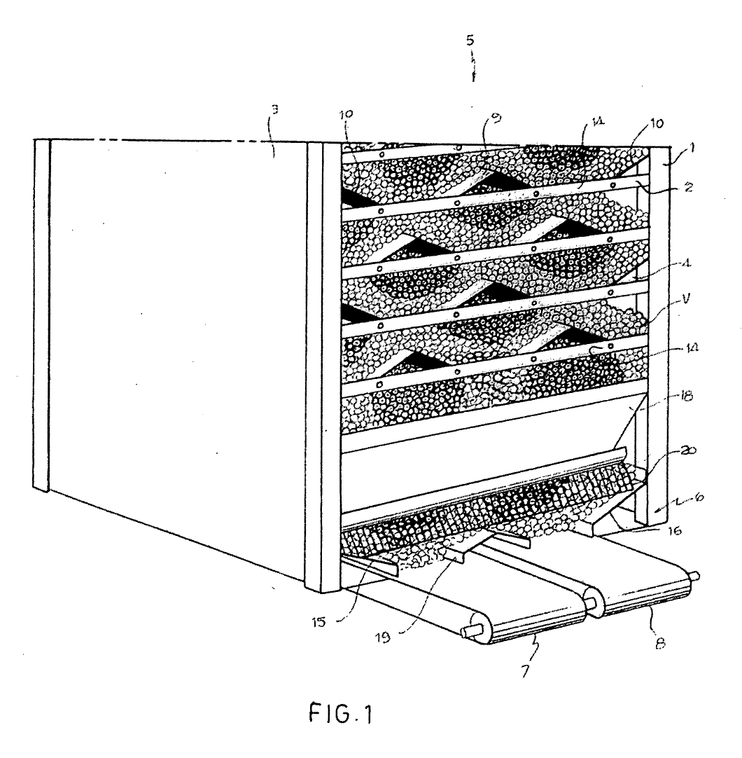

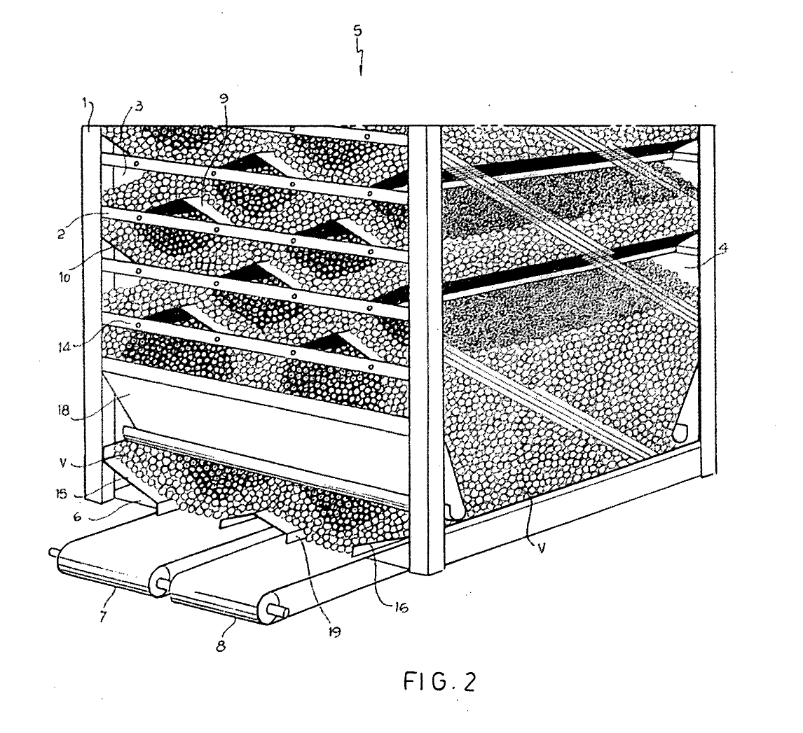

As may be seen in FIGS. 1 and 2, the flat bottom silo for storing and conveying light and empty containers in bulk of the instant invention is comprised by a metal structure constituted by corner columns (1), joined by means of horizontal cross members (2) distributed such as to assure a proper structural strength.

This structure is closed at the side (3), front (4) and rear walls, constituted by vertical rectangular partitions. Side walls (3) may be opaque or clear, while the front (4) and the rear walls will be preferably clear to allow a direct visual appreciation of the facts inside the silo.

Under the above conditions and according to what has been already defined, the silo of the invention comprises an inner transient storage housing, formed as a parallelepiped with rectangular walls, having a broad upper horizontal loading face (5) and a broad lower unloading horizontal face (6) wherein the motor powered conveying belts (7) and (8) are placed.

FIGS. 1 and 2 show the presence of multiple containers (V) stored transiently, distributed over the circulation spaces established by means of intermediate (9) and marginal (10) baffles.

Said baffle plates essentially prevent the formation of large accumulation columns of containers, thus assuring that the weight to be supported by each container during movement from one place to another does not affect or deform them.

On the other hand, the particular distribution of baffle plates also assure that containers flow naturally towards the lower discharge outlet, without undesirable jamming which could cause unwanted bruises.

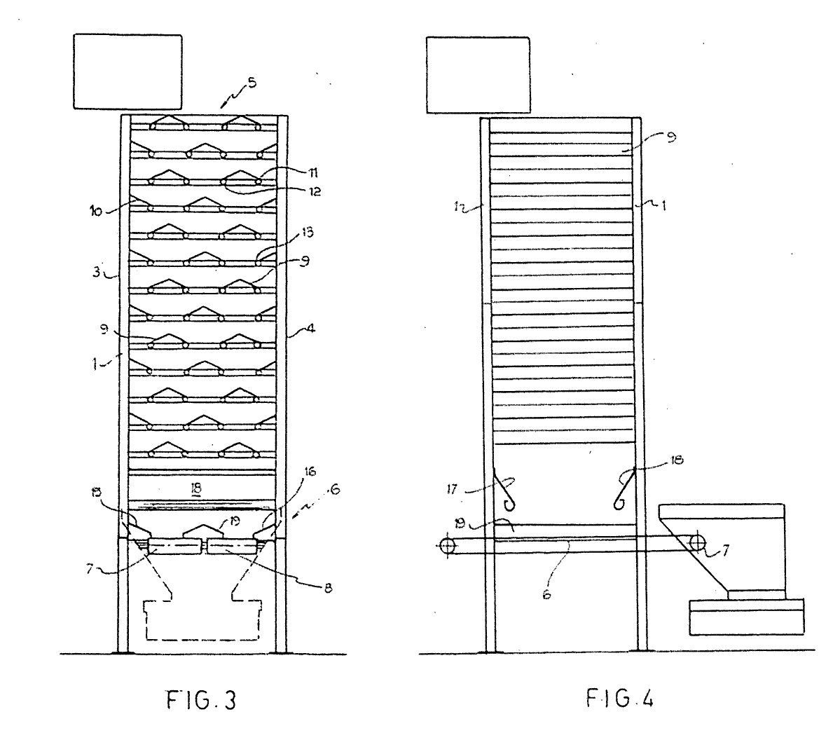

As may be seen also in FIGS. 3 and 4, the silo of the invention employs, in its transient storage housing, intermediate baffle plates (8) formed by folded steel sheet, to define two inclined faces oriented downwards.

It may be also seen that longitudinal edges (11) and (12) of said folded sheets, have respective folds towards the interior in order not to generate aggressive edges which could affect the containers.

Marginal baffle plates (10) also have their longitudinal edge (13) with the same converging fold.

FIGS. 1 and 2 also show that said intermediate baffle plates are fixed, through their ends, to cross profiles (14) extending at different heights fixed by their ends to columns (1).

Mounting of intermediate baffle plates (9) in said profiles (14) may be made by welding or bolting, in which case disk platelets may be used, with threaded holes, intercalated between the bearing ends of said plate (9) and the bearing point at said profile (14).

In this preferred example, the flat bottom silo for storing and conveying containers (V) of the invention, employs a plurality of horizontal rows of baffle plates, placed at different heights, alternating rows having two intermediate baffle plates (9) with rows comprised by corresponding marginal baffle plates (10) and an intermediate baffle plate (9) placed therebetween.

As mentioned, baffle plates (9) and (10), form a circuit for container circulation, wherein containers flow smoothly, without bearing large weights due to accumulation or undesirable jamming due to the existence of funnels or narrow portions.

Referring again to FIGS. 1 and 2, it may be seen that, mating with the lower horizontal unloading face (6), in front of conveying belts (7) and (8), two longitudinal marginal partitions (15) and (16) are provided, converging towards the conveying belts, which combine with corresponding cross marginal partitions (17) and (18) (FIG. 4), at a lightly upper height, the function of which is assuring that the containers being unloaded be duly oriented towards the upper face of both conveying belts (7) and (8).

Further, at the central separation space defined between both conveying belts (7) and (8), a lower protection curved mount (19) which, as shown in FIGS. 1 and 2, serves to orient containers (V) in order that they may reach the unloading region and being naturally deposited over the front face of both conveying belts, is provided.

There is also a lower front curtain (20) made of flexible and clear bands, whose function is to prevent containers from falling outside.

1. Flat bottom silo for storing and conveying light and empty containers in bulk, such as those of plastics molded by blowing and stored transiently, in line with further labeling and filling step, wherein the silo defines a transient storage housing having an upper loading mouth and a lower unloading bottom communicated with at least one engine powered conveying belt, from which the unloaded containers are moved, by other mechanical means, to the filling and labeling machines, as required, characterized in that into said transient storage housing there are ordered groups of provisory elongated baffle plates, distributed as per horizontal rows provided at different heights, (as a function of the strength capacity and dimensions of the containers), for avoiding the formation of excessive accumulation columns of containers; wherein said unloading bottom embraces a surface equivalent to the lower quadrangular base of the housing, in correspondence with which the engine powered belts are provided, which extended as per a horizontal plane, assist in exiting the containers being unloaded.

2. Flat bottom silo for storing and conveying light and empty containers in bulk, as claimed in claim 1, characterized in that the lower base defining the unloading opening of the housing, has the same size than the remaining portion of the cross section thereof.

3. Flat bottom silo for storing and conveying light and empty containers in bulk, as claimed in claim 1, characterized in that below the last row of baffle plates in correspondence with the unloading opening of the housing, there are engine powered conveying belts in the required amount for embracing the whole free surface determined at the lower basis of the silo.

4. Flat bottom silo for storing and conveying light and empty containers in bulk, as claimed in claim 1, characterized in that, in correspondence with the silo unloading opening, there are two conveying belts receiving the containers.

5. Flat bottom silo for storing and conveying light and empty containers in bulk, as claimed in claim 1, characterized in that, in correspondence with the silo unloading opening, there are more than two conveying belts receiving the containers extending coplanar for covering the whole unloading face.

6. Flat bottom silo for storing and conveying light and empty containers in bulk, as claimed in claim 1, characterized in that, in correspondence with the lower region of the housing, and inclined toward the conveying belts, there are transversely inclined short planar partitions, projecting from the side walls of the silo with a respective inclination converging towards said belts.

7. Flat bottom silo for storing and conveying light and empty containers in bulk, as claimed in claim 1, characterized in that a folded sheet acting as a lower orienting and offsetting mount is provided over the separation space between two adjacent conveying belts, so that the containers being unloaded be orderly distributed thereon.

8. Flat bottom silo for storing and conveying light and empty containers in bulk, as claimed in claim 1, characterized in that the elongated baffle plates are steel profiles extending, from end to end, between the front and rear faces of the silo, parallel to the side walls.

9. Flat bottom silo for storing and conveying light and empty containers in bulk, as claimed in claim 1, characterized in that the horizontal rows provided at different height levels, comprise at least two provisory support elongated baffle plates per row.

10. Flat bottom silo for storing and conveying light and empty containers in bulk, as claimed in claim 1, characterized in that the provisory support elongated baffle plates comprise intermediate plates formed by a line of longitudinal central fold for defining two downwardly inclined cross planes.

11. Flat bottom silo for storing and conveying light and empty containers in bulk, as claimed in claim 10, characterized in that the inclined planes formed at the intermediate plates form an angle of about 45° therebetween.

12. Flat bottom silo for storing and conveying light and empty containers in bulk, as claimed in claim 1, characterized in that the provisory support elongated baffle plates comprise marginal planar plates, inclined transversely downwards, projecting from the side walls of the silo.

13. Flat bottom silo for storing and conveying light and empty containers in bulk, as claimed in claim 1, characterized in that the horizontal baffle plate rows, provided at different heights, comprise at least two elongated baffle plates.

14. Flat bottom silo for storing and conveying light and empty containers in bulk, as claimed in claim 1, characterized in that the horizontal baffle plate rows, provided at different heights, comprise two marginal baffle plates and an intermediate baffle plate therebetween.

15. Flat bottom silo for storing and conveying light and empty containers in bulk, as claimed in claim 1, characterized in that inside the transient storage housing, the elongated baffle plates are distributed alternating horizontal rows with two intermediate baffle plates with horizontal rows comprised by corresponding marginal baffle plates and one intermediate baffle plate therebetween.

16. Flat bottom silo for storing and conveying light and empty containers in bulk, as claimed in claim 1, characterized in that each intermediate baffle plate of a row is laterally displaced with respect of the intermediate baffle plates of adjacent rows.
